(19) United States
(12) Patent Application Publication
(10) Pub. No.: US 2023/0182759 A1
(43) Pub. Date: Jun. 15, 2023

(54) METHODS AND SYSTEMS FOR IMPORIVING USER ALERTNESS IN AN AUTONOMOUS VEHICLE

(71) Applicant: AUTO TELEMATICS LTD, Yorkshire (GB)

(72) Inventors: Andrew William Wright, Yorkshire (GB); Gillian Switalski, Yorkshire (GB)

(73) Assignee: AUTO TELEMATICS, LTD., Yorkshire (GB)

(21) Appl. No.: 17/912,797

(22) PCT Filed: Mar. 18, 2021
(86) PCT No.: PCT/GB2021/050681

§ 371 Date: Sep. 19, 2022

(30) Foreign Application Priority Data
Mar. 20, 2020 (GB) 2004123.2

(51) Int. Cl. B60W 50/14; G07C 5/00; B60W 60/00

(52) U.S. Cl. CPC B60W 50/14; G07C 5/008; B60W 60/0053; B60W 2420/40; B60W 2420/42; B60W 2555/20; B60W 2556/45; B60W 2420/54; B60W 2050/143; B60W 2050/146; B60W 2050/0031

(57) ABSTRACT

There is provided a portable electronic monitoring device for providing an in-vehicle user warning system about how a semi-autonomous vehicle is being driven autonomously during a driving period. The device is removably and securely mountable to the vehicle and comprises: a sensor set comprising at least one sensor for sensing an exterior environment outside of the vehicle and movement of the vehicle within the exterior environment, an interface for receiving user input commands and delivering a warning output; and a processor operatively connected to the sensor set and the interface; wherein the sensor set is configured to monitor the automatic operation of the semi-autonomous vehicle within the exterior environment during the driving period and to generate sensor data representing driving events concerning the automated driving behaviour of the vehicle with respect to the exterior environment occurring during the driving period. The processor is configured to: process the sensor data during the driving period to compare the detected automated driving behaviour of the vehicle in the external environment with a model of expected automated vehicle driving behaviour for a particular driving event; identify a dangerous driving event, if the detected automated driving behaviour deviates beyond a threshold from the expected automated vehicle driving behaviour; and if a dangerous driving event has been detected, generate a warning alert via the interface to alert the driver to the occurrence of the dangerous driving event.

The disclosure is the U.S. National Stage of International Application No. PCT/GB2021/050681, filed on Mar. 18, 2021, which claims the priority benefit of GB Application No. 2004123.2, filed on Mar. 20, 2020. The entirety of the above-mentioned patent application is hereby incorporated by reference herein and made a part of this specification.

### TECHNICAL FIELD

The present invention relates to methods and systems for improving and maintaining user alertness in autonomous vehicles. More specifically, the present disclosure relates to the monitoring of autonomous vehicle operation and the alerting of users to potential hazards, threats, dangers, or circumstances that may require manual intervention. The present invention is particularly applicable to Level 2 autonomous vehicles and Level 3 autonomous vehicles but may be used in any manual or autonomous vehicle.

### BACKGROUND

The levels of autonomy in vehicles are defined by the Society of Automotive Engineers (SAE) International and extend from Level 0, where there is no automation of the vehicle and manual control is always required, to Level 5, where complete automation is achieved with no manual assistance required.

The transition from manually operated vehicles to autonomous vehicles began with small, incremental changes to achieve Level 1 autonomy. Cruise control, a form of autonomy in vehicles to maintain the speed of the vehicle at a desired level, was developed in the 1940s and 50s. Although cruise control does not meet the requirements for Level 1 autonomy, adaptive cruise control followed more recently, where the vehicle automatically adapts its speed to account for other vehicles. Later developments such as parking assistance and lane assistance are 21st century developments to assist drivers, referred to hereafter as users, in ordinary tasks, although user awareness is still required at all times in Level 1 vehicles.

Level 2 under the SAE classification introduces partial automation under certain conditions. The Tesla® Autopilot system is an example of a Level 2 system. The Autopilot system operates the vehicle in very specific circumstances by steering and regulating the speed of the vehicle. Although the Autopilot mimics a fully autonomous system, its capabilities are limited outside of the specific circumstances it is designed for. Therefore, the user is still required to be alert during operation of the vehicle.

Unfortunately, the illusion of complete autonomy provided by such systems is potentially dangerous if users do not understand the limitations of the system. There have been high profile incidents where a vehicle has been unable to return to manual control, has continued to operate autonomously, and ultimately malfunctioned or operated to cause serious injury to the user, passengers of the vehicle, or other road users.

Autonomy Level 3 has already been achieved in some vehicles, while the first Level 4 vehicles are expected to enter the market within a few years. While these systems have greater capabilities in a wider range of situations and circumstances, manual control will still be required at particular times. If a vehicle is unable to return to manual control, the user may be put in danger.

Furthermore, even though semi-autonomous vehicles are expected to reduce road traffic incidents to a large extent, the variety of potential hazards that vehicles are exposed to on the roads is huge. It is conceivable that until Level 5 autonomy is achieved, vehicle systems will not be completely infallible. Situations that the vehicles should be able to operate in comfortably may cause unexpected problems, for example if a minor malfunction occurs in a sensor.

In a more general sense, it is important to bear in mind the context of autonomous vehicles in society. They are primarily a means of transportation and must be accepted as such. Acceptance is dependent upon all road users, including the vehicle user and driver, passengers, other vehicle users/operators, and pedestrians, trusting that autonomous vehicles are safe. Accordingly, any achievable improvement in trust of autonomous vehicles is desirable.

### SUMMARY OF THE INVENTION

According to an aspect of the invention, there is provided a portable electronic monitoring device for providing an in-vehicle user warning system about how a semi-autonomous vehicle is being driven autonomously during a driving period. The device is removably and securely mountable to the vehicle. The device comprises a sensor set comprising at least one sensor for sensing an exterior environment outside of the vehicle and movement of the vehicle within the exterior environment. The device comprises an interface for receiving user input and delivering output. The device comprises a processor operatively connected to the sensor set and the interface. The sensor set is configured to monitor the automatic operation of the semi-autonomous vehicle within the exterior environment during the driving period and to generate sensor data representing driving events concerning the automated driving behaviour of the vehicle with respect to the exterior environment occurring during the driving period. The processor is configured to: process the sensor data during the driving period to compare the detected automated driving behaviour of the vehicle in the external environment with a model of expected automated vehicle driving behaviour for a particular driving event; identify a dangerous driving event, if the detected automated driving behaviour deviates beyond a threshold from the expected automated vehicle driving behaviour; and if a dangerous driving event has been detected, generate a warning alert via the interface to alert the driver to the occurrence of the dangerous driving event.

Advantageously, the provision of a device as described above permits a driver or user of the vehicle to ensure that the vehicle is operating correctly when in an autonomous driving mode. The device may be configured to have a lower level of tolerance in relation to external vehicle events and threats so that it reacts to the vehicle's operation in a more critical manner. By having a further, independent warning system, the user can be comfortable in knowing that they are safe and that their vehicle's operation is being reviewed and checked by a separate system. In this regard, the monitoring device plays no part in controlling the vehicle itself but rather alerts the driver when necessary to either take control themselves (namely override the autonomous operation mode of the vehicle bringing the vehicle back into the driver's control). The device adds an extra level of security in addition to the driver's own oversight of the vehicle's operation. The user may therefore engage less with the vehicle unless it is absolutely necessary. In some circumstances, the additional security provided by the device may lead to lower insurance premiums.

While the above refers to semi-autonomous vehicles and autonomous operation, the device may also be used in settings where the vehicle is driven manually and where the user is not the driver. For example, in ride-sharing situations, the device may be used to check the driver's driving is up to the required standard.

The at least one sensor may comprise a proximity sensor. The proximity sensor may comprise an infrared sensor, a camera, and/or an ultra-wide band sensor. The sensor set may include at least one external weather monitoring sensor. The at least one external weather monitoring sensor may comprise a barometer and/or an ambient light sensor. The sensor set may include at least one positional sensor. The at least one positional sensor may comprise a gyroscope, a magnetometer, an altimeter, a geolocation sensor, and/or an accelerometer. The sensor set may include an audio sensor. The sensor data may include audio signals. It is to be appreciated that some of these sensors can be implemented by a combination of a camera of the device and a software algorithm being run by the processor of the device to process the captured images to derive a particular measure. For example, the proximity sensor can be implemented in some embodiments by the camera capturing images of vehicles in the external environment and the algorithm determining the proximity of the vehicle from the size of a representation of the vehicle within the image. Other examples include the ambient light sensor which may determine, using a software program, the ambient light as a function of the brightness of the captured image by the camera.

In some embodiments, the portable monitoring device comprises a local wireless communications link to a personal telecommunications device (such as a smartphone) which provides a user interface to the monitoring device. This advantageously reduces the size and cost of the portable monitoring device and takes advantage of the fact that most drivers own smartphones. However, in other embodiments, the portable monitoring device can include the user interface and can in some embodiments be a smartphone itself, programmed with a downloadable app. This alternative can reduce costs further as the device does not have to be provided itself but rather a general-purpose smartphone of the driver can simply be configured to act as the monitoring device by downloadable software.

The interface may in some embodiments comprise a touchscreen and a loudspeaker. The interface may in some embodiments comprise a projector configured to project images onto a surface (such as the windscreen) of the vehicle to create a head-up display.

Optionally, the portable electronic monitoring device comprises a wireless communications engine for communicating with a remote server, wherein the wireless communications engine is configured to receive information regarding the external environment through which the vehicle is travelling.

Optionally, the portable electronic monitoring device comprises an AI engine configured to operate as a neural network for learning and modelling autonomous behaviour of the vehicle, the processor being operatively connected to the AI engine. The AI engine may comprise a neural network trained to model expected vehicle driving behaviour. The neural network may be trained using sensor data collected from manual and/or automated operation of the vehicle prior to the current driving period. The sensor data collected prior to the current driving period may be data that has been validated as being sensed in one or more driving periods during which no dangerous driving events were identified. Based on the neural network and sensor data, the AI engine may be configured to generate the model of expected automated vehicle driving behaviour for the particular driving event.

Optionally, the processor is configured to: determine a threshold for the particular driving event; and, if the comparison between the detected automated driving behaviour and the model of expected automated vehicle driving behaviour for the particular driving event indicates that a deviation has occurred: compare the deviation and the threshold to determine if the deviation is beyond the threshold.

The threshold may be determined based on the driving event and at least one other parameter selected from the group consisting of: a reaction time of the driver; a level of autonomy of the vehicle; condition of the vehicle; a road type; a weather condition; and one or more user settings. Where the at least one other parameter comprises the reaction time of the driver, the sensor set may include at least one sensor for sensing an interior environment of the vehicle. The processor may be configured to determine the reaction time of the driver based on current and/or historical sensor data sensed from the sensor for sensing the interior environment of the vehicle. Where the driving event comprises a vehicle manoeuvre, the threshold may be based on one or more of: vehicle speed during the manoeuvre; vehicle braking during the manoeuvre; and vehicle steering angle during the manoeuvre. Where the driving event comprises an interaction with another vehicle, the threshold may be based on one or more of: the speed of one or each vehicle during the interaction; vehicle braking during the interaction; the proximity of the other vehicle; the direction of travel of the other vehicle; the location of the other vehicle; whether the other vehicle is recognised as operating or capable of operating autonomously; and/or the behaviour of the other vehicle.

The processor may be configured to: determine a classification framework for the particular driving event; assign a value to the deviation of the detected automated driving behaviour from the expected automated driving behaviour based on the classification framework; and compare the value with the predetermined threshold, and wherein the threshold is a value on the classification framework. The classification framework may comprise a plurality of discrete category values. The classification framework may comprise a continuous numerical scale of values.

A plurality of thresholds may be provided for identifying a dangerous driving event. Each threshold of the plurality of thresholds may correspond to a different warning signal.

Optionally, the sensor set includes at least one sensor for sensing an interior environment of the vehicle. The sensor set may be configured to monitor the interior environment of the vehicle during the driving period and to generate sensor data representing a current attention state of the driver during the driving period. The processor may be configured to: determine a required attention state of the driver with respect to the current operation of the semi-autonomous vehicle within the exterior environment; compare the current attention state of the driver and the required attention state of the driver; and generate a warning alert signal if the current attention state deviates beyond a threshold value from the required attention state. The required attention state may be determined based on one or more vehicle parameters. The one or more vehicle parameters may include a level of autonomy of the vehicle, a vehicle speed, a vehicle occupancy level, and/or a quality of autonomous vehicle operation. The required attention state may be determined based on one or more external environment parameters.

The one or more external environment parameters may include a road type, a road quality, a traffic density, a weather type, a classification of how urban or rural the environment is, driving behaviour of other vehicles in the vicinity, and/or the presence of one or more dangerous driving events and/or other threats.

The processor may be configured to, if a dangerous driving event is detected, determine a time point before which resumption of manual control of the vehicle is necessary, and to generate the warning signal before the time point at the latest.

In some embodiments the device is a smartphone, which can be configured by downloadable applications.

### BRIEF DESCRIPTION OF THE DRAWINGS

Embodiments of the invention will now be described, by way of example only, with reference to the accompanying drawings, in which:

FIG. 1A is a schematic representation of a known semi-autonomous vehicle system;

FIG. 1B is a schematic representation of a known semi-autonomous vehicle;

FIG. 2A is a schematic representation of a semi-autonomous vehicle system incorporating a mobile telecommunications device according to an embodiment of the present invention;

FIG. 2B is a schematic representation of a semi-autonomous vehicle incorporating a mobile telecommunications device according to an embodiment of the present invention;

FIG. 3 is a schematic representation of the mobile telecommunications device of FIG. 2B according to an embodiment of the invention;

FIG. 3A is a schematic representation of a set of sensors used in the mobile telecommunications device of FIG. 3;

FIG. 4 is a flow chart illustrating a method of set-up of the mobile telecommunications device of FIG. 3;

FIGS. 5 to 10 are flow charts illustrating methods of analysing monitoring data gathered during the method of FIG. 4 using the mobile telecommunications device of FIG. 3; and

FIG. 11 is a flow chart illustrating an alert method for alerting the user using the mobile telecommunications device of FIG. 3 following one of the methods of FIGS. 5 to 9 identifying that an alert is required.

### DETAILED DESCRIPTION

### Description of the Prior Art

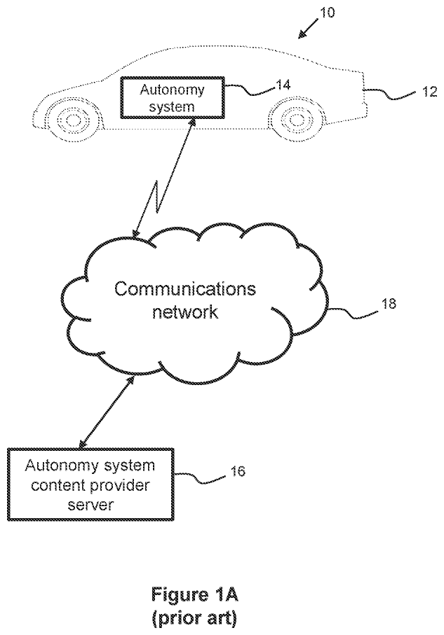

FIG. 1A illustrates a known system 10 for semi-autonomous vehicle information exchange. The system 10 comprises a semi-autonomous vehicle 12 having an autonomy system 14 provided therein connected wirelessly to an autonomy system content provider server 16. The communications network 18 is a wide-area network such as the internet. Communication between the vehicle 12 and server 16 is permitted across the communications network 18 using a suitable wireless communications protocol such as 3G/4G/5G or through a series of Wi-Fi localised regions (Wi-Fi hot spots) which together make up wireless mesh network, for example.

To provide setting for FIG. 1A, the semi-autonomous vehicle 12 is depicted in more detail, schematically, in FIG. 1B. The following paragraphs refer to both FIGS. 1A and 1B. The vehicle 12 in FIG. 1B has four wheels 20 (two are shown in FIG. 1B) and an interior 22 arranged in the conventional manner. The interior 22 is depicted having a set of front seats 24, a set of back seats 26, and a steering wheel 28 mounted to a dashboard 30. It will be appreciated that the interior 22 contains components other than those depicted here, including those that are used by the user to manually operate the vehicle 12, such as acceleration and brake pedals, and ancillary operations switches, such as indicators, windscreen wiper operators, or headlight buttons. A driver of the vehicle 12, referred to a user 32 hereafter, is seated in a front seat 24. The user 32, as referred to in this application, is the operator of the vehicle 12, particularly the operator that manually controls of the vehicle 12 when manual control is required. The interior 22 of the vehicle 12 may be laid out differently.

An autonomy system 14 is provided in the vehicle 12. The autonomy system 14 is integrated into the vehicle 12 in order to provide autonomous or semi-autonomous functions specific to that vehicle 12 such as autonomous driving in particular conditions and circumstances. The autonomy system 12 receives sensor data from a plurality of vehicle-mounted sensors 34 (such as cameras and proximity sensors for example) and/or the engine management system 36 (which generates a plurality of parameters regarding the condition and movement of the vehicle) and utilises the received data to control the operation of the vehicle 12, either internally or with reference to data from a remote system such as the autonomy content provider server 16. The vehicle 12 is therefore semi-autonomous and can be assigned at least Level 2 autonomy on the SAE International Scale. Accordingly, in the conditions under which autonomy is permitted, the user does not have to manually operate the vehicle 12.

Instructions and data relating to the autonomous operation of the semi-autonomous vehicle 12 by the autonomy system 14 are exchanged wirelessly via the communications network 18 as shown in FIG. 1A. In this regard, the autonomy system 14 has a built-in wireless transmitter and receiver (not shown) for communication with the autonomy system content provider server 16 via the communications network 18. The semi-autonomous vehicle 12 is capable of sensing its environment and collating sensor data relating to the environment using the autonomy system 14. The vehicle 12 responds to situations it is presented with based on the collated sensor data. The response (for example, a vehicle control response) is typically determined locally, within the autonomy system 14, for the shortest reaction times but for certain types of response may be determined remotely, at a remote processing system if the situation does not require an immediate time-critical response. The autonomy system content provider server 16 is a remote processing system, according to whose instructions the vehicle may be operated via the autonomy system 14. For example, the remote processing system may have access to traffic information and generate an instruction to make a vehicle speed adjustment to anticipate the forthcoming traffic. In addition, the autonomy system content provider server 16 may provide information to the autonomy system 14 to enable decisions to be taken locally within the vehicle 12 by the autonomy system 14, such as mapping information. Data gathered by the autonomy system 14 in the semi-autonomous vehicle 12 may also be uploaded to the autonomy content server provider 16 for analysis or later use.

Although only one semi-autonomous vehicle 12 is illustrated in this embodiment a plurality of other semi-autonomous vehicles (not shown) is typically in communication with the first content provider server via the communications network. In another embodiment, a plurality of fully autonomous vehicles is also provided. Similarly, in another embodiment, a plurality of autonomy content provider servers is provided, each connecting with a different set of semi-autonomous vehicles.

In all semi-autonomous vehicles (i.e. SAE Levels 1 to 4), the user has to be able to provide manual control of the vehicle in particular circumstances (for example where the autonomy system has made a mistake based on its sensor inputs), and should be alert and ready to provide such manual override control. This definition will be adopted herein: a semi-autonomous vehicle is a vehicle capable of being operated both manually and autonomously. In the lower Levels, the user should also be monitoring the operation of the vehicle in order to retake control if it is determined (by the vehicle or the user) that an error has occurred or that manual control is required to prevent a dangerous driving situation, for example. However, the greater the level of autonomy of the semi-autonomous vehicle, typically the less attention the user pays to the driving circumstances as the user assumes more trust in the autonomy system to control the vehicle. However, it is exactly this issue which causes problems in that there is a greater risk of a mistake of the semi-autonomous vehicle being unnoticed by the user and, as a result, the vehicle may cause an accident or crash.

### Detailed Description of the Present Embodiments

The present embodiments are directed to overcoming this problem with known semi-autonomous vehicles. In order to provide oversight of the operations of the semi-autonomous vehicle and of the behaviour of the user when the semi-autonomous vehicle is operating autonomously, an independent, supervisory monitoring system is provided. The monitoring system is embodied in a portable mobile telecommunications device which has its own sensor set and ability to process data received from its sensor set. A non-limiting example of this may be a smartphone, for example. The portable mobile telecommunications device is removably provided in a vehicle to monitor the autonomy system of that vehicle. The portable device is, in use, removably attached or affixed to the vehicle (for example via a holder or mount) and is positioned typically on a windscreen such that the portable mobile telecommunications device is able to use its sensors to monitor the environment around the vehicle. In some embodiments, the portable mobile telecommunications device comprises a smartphone with rear and forward-facing cameras running a downloaded application which configures the smartphone to operate as a monitoring system during a driving period when the semi-autonomous vehicle is being driven by the autonomy system. The smartphone embodiment is described in greater detail later.

Favourably, the oversight provided by the supervisory monitoring system may be more critical and wary of hazards than is determined by the operation of the autonomy system without affecting the autonomous operation of the vehicle. The present embodiments enable a higher degree of caution to vehicle hazards and driving events compared with the autonomy system built into the vehicle. This enables the supervisory monitoring system to add an extra layer of safety in maintaining a cautious view of the driving environment and acting as a safe companion to the user. In addition, whilst there are currently no standards applicable to such semi-autonomous vehicles and autonomy systems, the present embodiments provide a way of monitoring all of the different proprietary systems integrated into different vehicles using an independent non-proprietary system. In other words, the supervisory monitoring system is operable to monitor the vehicle's autonomous operation and ensure that its autonomy is not leading to dangerous driving. If dangerous driving events are identified, the system acts to alert the user using its integrated sensor set and interface.

Accordingly, the present embodiments provide an advantageous way of providing a consistent standard across all autonomy systems in autonomous and semi-autonomous vehicles without requiring all of the manufacturers to change their independent development of those autonomy systems. A further advantage is achieved because another layer of safety can be built into the autonomy system, which in turn enables vehicle insurance premiums to be lowered/reduced. The user may also feel a greater level of trust in the vehicle's autonomy if they are able to monitor independently both the data that they can gather using their own senses and data gathered by the independent supervisory monitoring system.

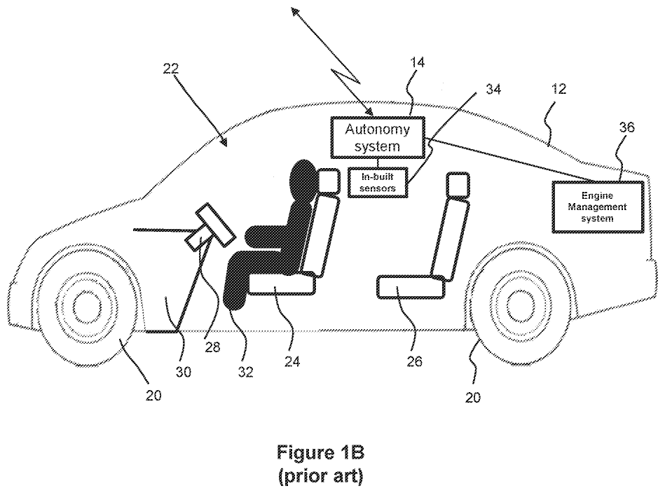

The supervisory monitoring system is depicted in FIG. 2A and FIG. 2B. FIG. 2A illustrates a system 38 for semi-autonomous vehicle information exchange. The system 38, in common with the known system of FIG. 1A, comprises a semi-autonomous vehicle 12 having an autonomy system 14 provided therein connected wirelessly to an autonomy system content provider server 16. The communications network 18 is a wide-area network such as the internet. Communication between the vehicle 12 and servers 16 is permitted across the communications network using a suitable wireless communications protocol such as 3G/4G/5G or through a series of Wi-Fi localised regions (Wi-Fi hot spots) which together make up wireless mesh network, for example. Where FIG. 2A differs from FIG. 1A is that there is also provided a supervisory system 40 within the autonomous vehicle 12 connected wirelessly to a supervisory system content provider server 42 via the communications network 18. Where appropriate, monitoring data collected by the supervisory monitoring system 40 relating to the operation of the vehicle 12 and behaviour of the user when the vehicle 12 is operating autonomously is exchanged via the communications network 18. The supervisory monitoring system 40 analyses collected monitoring data locally and/or communicates the collected data to the supervisory system content provider server 42 for remote analysis (particularly when greater processing power is required).

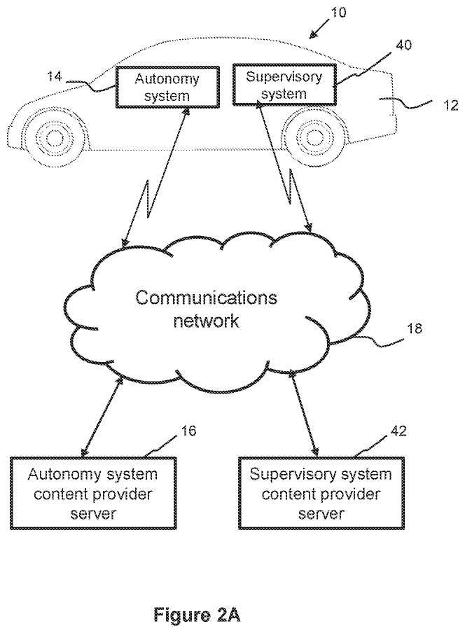

The supervisory system 40 is shown in FIG. 2B as being removably mounted in the autonomous vehicle 12 in front of the user 32, i.e. to the windscreen of the vehicle 12. The autonomy system 16, in-built sensors 34, engine management system 36 and user 34 are also depicted within the vehicle 12 of FIG. 2B, in the same way as depicted and described in relation to FIG. 1B. From its mounting 44, the supervisory monitoring system 40 monitors one or more of the interior of the vehicle 12, the external environment of the vehicle 12, and the general autonomous operation of the vehicle 12 within the external environment. Generally, monitoring the external environment comprises monitoring the forward direction of travel of the vehicle 12, although in some embodiments, the external environment to the sides of the vehicle 12, to the rear of the vehicle 12, and underneath the vehicle is also monitored using appropriate hardware. The use of additional hardware and the monitoring hardware of the system are discussed later in relation to FIGS. 3 and 3A.

In its oversight role, the supervisory monitoring system 40 monitors at least one aspect of the semi-autonomous vehicle 12 that may present a risk to the user 32, to the vehicle 12, or to the continuity of the vehicle's autonomous operation independently of the autonomy system 14. When discussing the independence of the supervisory monitoring system 40 herein, it is meant that the supervisory monitoring system 40 monitors and analyses data separately, without input from or output to the autonomy system 16. In addition to providing monitoring duties, the supervisory monitoring system 40 also provides alerts to draw the user's attention to identified hazards as required. The terms ‘user’ and ‘driver’ have been used interchangeably throughout this specification.

To provide oversight, the supervisory monitoring system 40 utilises sensor data to monitor potential hazards. The supervisory monitoring system 40 may operate to analyse the autonomy system 16 in one or more of at least two modes of operation in which different sensor sets provide the relevant data used by the supervisory monitoring system 40 to determine hazards. In a supervisory embodiment or a supervisory configuration (mode of operation), the supervisory monitoring system 40 is entirely separate from the autonomy system 16. In this mode, the supervisory monitoring system 40 receives data from a set of sensors that are not part of the in-built sensors 34 of the vehicle 12 and processes and communicates the data using processing and communications systems which are not part of the autonomy system 14. In other words, in the supervisory mode of operation the supervisory monitoring system 40 and the autonomy system 14 do not share any of the same systems or data. Alternatively, in a confirmatory embodiment or a confirmatory configuration (mode of operation) to the above-described supervisory monitoring embodiment, the supervisory monitoring system 40 may play the role of observer, monitoring and analysing data received by the autonomy system to ensure that the decisions the autonomy system 14 makes are as expected based on the received data. In this embodiment, the supervisory monitoring system 40 and the autonomy system 14 share data streams but operate to process and communicate the data separately. In order to do this, the supervisory monitoring system 40 is configured to interface with the vehicle 12 in some respect. In some embodiments, the supervisory monitoring system 40 is connected to the vehicle 12 via a USB port, or using the vehicle's on-board diagnostics (OBD) port. In the following description, it is assumed that the supervisory monitoring system is the former (supervisory monitoring embodiment), and is totally independent of the autonomy system, although it will be appreciated that the same concepts can equally be applied to the latter system (confirmatory embodiment).

The supervisory monitoring system 40 is capable of being incorporated into a vehicle 12 as software running on vehicle hardware, and/or as separate hardware with dedicated modules and/or running bespoke software. In the non-limiting example above, the supervisory monitoring system comprises a portable electronic monitoring device, particularly in this embodiment a portable telecommunications device (also referred to as a mobile telecommunications device or mobile device herein), such as a smartphone. This mobile device has dedicated function modules and/or downloaded bespoke software (applications) to enable it to provide the relevant oversight functions. Providing a mobile device as part of the supervisory monitoring system enables independence from the autonomy system as well as vehicle-agnosticism, i.e. the mobile device is configurable in any semi-autonomous vehicle to provide independent oversight of the vehicle's operation. The mobile device provides sensors and output hardware that enable the oversight functions and alert functions required to act in the capacity of the supervisory monitoring system. By mobile, it is meant that the device is portable by the user, and removable from the vehicle in a straightforward manner, namely by any user and does not require a trained technician for removal.

The use of a mobile device for this form of supervisory assistance ensures that sufficient sensing, processing, and alert hardware is provided in a suitable form. If the mobile device is the personal smartphone of the user, then the user is likely to have the device with them at all times, so that the system can be set up in any desired vehicle with relative ease by the user, for example by placing in a smartphone holder mounted to a dashboard of the vehicle 12. The benefits of the system will be further described below, in relation to the features described in relation to the later figures.

As shown in FIG. 3, an example mobile device 50 includes a main processor 52 connected to a monitoring system 54. The monitoring system 54 comprises sub-processors in the form of an external environment monitoring processor 54a, a user monitoring processor 54b, and a vehicle monitoring processor 54c. In use, the monitoring system 54 interacts with other modules of the mobile device 50 shown in FIG. 3 via the main processor 52 to enable the mobile device 50 to act as the supervisory monitoring system 40. The monitoring system 54 receives data from the sensors 56 and/or other modules of the mobile device 50 and analyses the received data. Based on the analyses performed by the monitoring system 54 and the results generated and sent to the main processor 52, the main processor 52 determines actions regarding the semi-autonomous driving of the vehicle 12 to be taken.

Within the mobile device 50, the main processor 52 is also in communication with an alert system 58, a navigation system 60, a user interface 62, a communications engine 64, and a data store 66. The alert system 58 comprises a signal generator (not shown) for creating a control signal to cause the mobile device 50 to generate a sensory alert, in this embodiment, using its built-in user interface 62. This sensory alert may be a vibration of the mobile device 50 via a haptic motor of the mobile device 50, an auditory alert generated from a loudspeaker of the mobile device 50 and/or a visual alert generated by a particular illumination of a display of the mobile device 50, such as a flashing illumination to catch the attention of the user. In other embodiments, the mobile device 50 may not have a user interface and may instead use the user interface of a user's personal mobile telecommunications device (such as a smartphone) to interface with the mobile device 50. In this embodiment, the personal user smartphone may be wirelessly and operatively coupled to the mobile devices, for example via a Bluetooth® connection.

The mobile device 50 of FIG. 3 has a plurality of different sensors 56. A sensor set 68 from which sensors 56 of the mobile device 50 may be chosen is shown in FIG. 3A. A core set of sensors 70 is indicated by the dotted line in FIG. 3A. The core set 70 of sensors comprises one or more cameras 72, one or more microphones 74, one or more accelerometers 76, a gyroscope 78, and the sensors of the navigation system 60: a location determining sensor 80, such as a GPS receiver, for determining a current location of the mobile device 50; and a geographic compass 82 or compass functionality using a magnetometer sensor of the mobile device 50. Other forms of geographic location-determining sensors can also be provided such as terrestrial radio positioning systems, location sensors using the Doppler Effect or Wi-Fi hot spot location sensors. The non-core sensors of the mobile device 50, outside of the dotted line, include an altimeter 84 for determining the location of the device 50 above sea level. This provides assistance to the determination of the geographic location of the mobile device 50 and also help to better understand external weather conditions. Another sensor is a barometer sensor 86, provided to give an indication of the current atmospheric pressure being experienced by the mobile device 50, again to assist with determining and corroborating external weather conditions. Ambient light sensors 88 may be configured determine the external lighting conditions which can help with adjustments in safety thresholds due to current visibility in the available ambient light. An infra-red proximity sensor 90 enables detection of presence of a subject in the vehicle 12 or to corroborate positional images of a driver of the vehicle 12 captured by the rearward-facing (in relation to the vehicle) cameras for example, in poor ambient lighting conditions. One or more Ultra-Wide Band (UWB) sensors 92 are provided to detect objects within the field of view of the sensor(s) (occupants present in the vehicle 12 as well as objects present in the vicinity of the vehicle 12 for example other vehicles or objects). Clearly as UWB sensors 92 are directional, if both the interior of the vehicle 12 and the exterior of the vehicle 12 are to be monitored, then two such UWB sensors 92 will be required that face in opposing directions. The use of one or more UWB sensors 92 which use pulsed radar transmission and reflection is advantageous because unlike visual images captured by cameras, they are not sensitive to ambient lighting conditions whereas camera-based techniques cannot perform in dark environments.

The above-described sensor set 68 shown in FIG. 3A can be provided in different combinations in different embodiments of the present invention. Whilst a core set 70 of sensors is indicated by the dotted line in FIG. 3A, the use of an altimeter 84 or a barometer 86 is not necessary in some embodiments. Similarly, ambient light sensors 88 and IR proximity sensors 90 are optional in some embodiments, because the captured camera images may also be able to detect that the ambient light level using an image processing algorithm. Finally, the use of an UWB sensor 92 with the core set 70 of sensors is also optional in other embodiments but does provide a significant benefit when determining object location in low light or poor visibility conditions both externally and internally within the vehicle 12.

When considering the sensors 56 and the monitoring capabilities of the supervisory monitoring system 40 in general, it is the external environment in the forward direction of travel of the vehicle 12 that is monitored by the supervisory monitoring system 40 at the least. Where possible, the supervisory monitoring system 40 is also configured to monitor the external environment in the rearward direction of travel of the vehicle 12, and/or either side of the vehicle 12. Where the supervisory monitoring system 40 is incorporated into a mobile device 50, additional monitoring capabilities, such as the ability to monitor different areas relative to the vehicle 12 are achieved by providing further mobile devices that connect wirelessly or otherwise to the original mobile device 50. For example, in embodiments where the supervisory monitoring system 40 is configured to monitor the external environment to the sides of the vehicle 12, sideways-facing camera modules are connected to the mobile device 50 for monitoring the external environment via the driver and passenger side windows. In embodiments where the supervisory monitoring system 40 is configured to monitor the external environment to the rear of the vehicle 12, a camera module is mounted within the vehicle 12 near the rear windscreen to provide oversight of the rear of the vehicle 12. The side-facing and rearward-facing camera modules may be incorporated into additional mobile devices. Furthermore, where the supervisory monitoring device 40 has multiple cameras with different fields of view facing in the same direction as is often the case in modern smartphones, images captured by the different cameras are used by the supervisory monitoring system for different purposes. For example, a camera with a wide-angle lens will have a wide field of view and so could capture external activity to the vehicle 12 at the sides thereof without the need for sideways facing cameras. Similarly, a telephoto lens (zoom lens) is useful in a situation where a rearward facing camera (with respect to the vehicle) in a supervisory monitoring device, mounted to a front windscreen or dashboard, can view activity occurring externally behind the vehicle 12 through the rear windshield of the vehicle 12.

Turning back to FIG. 3, the user interface 62 enables the user to input commands to the mobile device 50, and enables output of information, such as sensory alerts, to the user. The communications engine 64 enables communication between the mobile device supervisory monitoring system 40 and the content provider server 42 via the communications network 18, as shown in FIG. 2A.

In alternative embodiments or additionally, the data store 66 stores a monitoring software program that when executed on the main processor 52 enables the mobile device 50 to act as the supervisory monitoring system 40. For example, an application or ‘app’ downloadable from a content provider (such as the App Store®) may be stored as the executable monitoring software program and selectable for running by the user.

The present embodiment shown in FIG. 3 also includes a dedicated AI (Artificial Intelligence) processor 94 which is configured to operate as a neural network. The AI processor 94, also referred to as an AI engine, is used to analyse data generated by the sensors 56 during periods of autonomous driving carried out by the autonomy system 14. Patterns of driving and in particular how the autonomy system reacts to different driving events (such as another vehicle changing lanes in front of the present vehicle suddenly) can be monitored and a model (not shown) describing how the autonomy system 14 of this vehicle works can be determined. This model of how the autonomy system operates, particularly when significant driving events occur, can be built up and used to predict how the autonomy system 14 will react. Such a model can then be used by the main processor 52 as a predictive model in a semi-autonomous vehicle 12 to determine whether the supervisory monitoring system 40 needs to generate an alert for the user to intervene, earlier than is possible otherwise. The alert is generated earlier because the supervisory monitoring system 40 uses the predictive model and acts on a prediction of what action the autonomy system 14 will take rather than reacting to the action that the autonomy system 14 does take. In addition for semi-autonomous driving, reaction times for a user to intervene in an incident can be monitored and used to determine a likely reaction time for a given incident. Different users have different reaction times and so alert generation timing can be adjusted accordingly, bringing forward alert generation for drivers with slow reactions for example. The trained AI model of this vehicle 12 which is created on the mobile device 50 can be uploaded to the supervisory system content provided server 42 for subsequent use and storage if required. The AI engine comprises and operates as a neural network. The neural network is trained to model vehicle behaviour using data gathered during operation of the vehicle. The operation during which the data is collected may be autonomous operation or manual operation. During either circumstance, a user will be required to confirm, via the user interface, that, during the driving period in which the data was collected, no dangerous or unexpected driving events occurred. That is, that during training, a user is present in the vehicle to confirm the beginning of a training driving period. The user pays attention (as normal, if manual operation, or to the autonomous operation if operating autonomously) to the operation of the vehicle throughout the training driving period. At the end of the training driving period, the device requests confirmation and validation from the user that the data gathered during the training driving period is suitable for training the neural network. If the user confirms that it is suitable, the AI engine updates the neural network based on the collected data. Otherwise, the data is discarded. The user may be the vehicle owner or may be a technician. In some circumstances, the neural network may be trained with data gathered from a vehicle of the same type and downloaded to the device based on a user inputting the type of vehicle being operated.

It will be appreciated that the mobile device 50 of FIG. 3 is provided by way of example, and that in other embodiments, the mobile device 50 incorporated additional modules not shown in the figures and/or is connected to additional modules to further enhance the operation of the supervisory monitoring system 40. For example, additional alert modules, such as a projector configured to create a head-up display on the vehicle windscreen or two sets of lights, one either side of the mobile device 50, paired with the mobile device 50 would provide real-time tracking of hazards for the user. Such additional modules may be incorporated into, i.e. be integral with, the mobile device 50, may be incorporated into a cradle or a holder to which the mobile device 50 is mounted, or may be incorporated elsewhere in the vehicle 12.

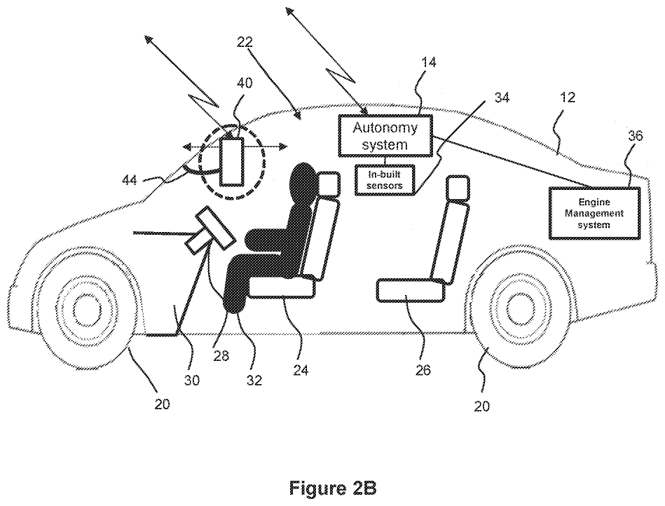

The supervisory monitoring system 40 is operated according to one or more supervisory processes, examples of which are provided in the flow charts of FIGS. 4 to 11. Each of the processes of FIGS. 4 to 11 are described in relation to the supervisory mobile telecommunications device 50 shown in FIG. 3, although it will be appreciated that the processes may be applied to any form of supervisory monitoring system 40, particularly portable systems.

FIG. 4 is flow diagram showing a preliminary method, beginning at A, for device set-up. At a first stage of the method 400, the mobile device 50 is configured, at Step 402, in the vehicle 12. The configuration of the mobile device 50 at Step 402 comprises at least one configuration process. Various configuration processes are discussed below.

In one configuration process, the mobile device 50 is configured by positioning it in the vehicle 12 to enable correct and full monitoring. In this process, if the mobile device 50 is a smartphone, the process comprises removably mounting the mobile device 50 to the vehicle 12 using a cradle or a holder so that a rear camera(s) of the mobile device 50 face the exterior of the vehicle 12 (forward facing) and the front camera(s) of the mobile device 50 along with the device screen face the interior of the vehicle 12 and particularly the user (rearward facing in relation to the vehicle 12). Suitable locations for the cradle or holder would be on a dashboard or to a front windscreen of the vehicle, for example. FIG. 2B, shows one possible position with the mobile device 50 located near the front windscreen with a good view of the road ahead as well as the interior of the vehicle 12.

In another configuration process, configuration 400 comprises running a configuration process on the mobile device 50 in order to calibrate the sensors 56 and to ensure that they are correctly positioned. If any part of the mobile device 50 is incorrectly configured, the user is provided with instructions to rectify the configuration. The mobile device 50 analyses the image received from the rear-facing camera 72 of the device 50, which is positioned to face the external environment of the vehicle 12. The analysis of the image is performed to determine that the orientation and angle of the mobile device 50 relative to the driving surface and to the vehicle 12 is correct, and that there are no obstacles in the image (namely the camera's field of view) that could cause errors in later processing. Similarly, if the UWB sensor 92 is being used, it is important to configure this ensure that there are no objects obscuring a part of the field of view (for example on the dashboard) which may distort the results. The mobile device 50 may also analyse images obtained from the front-facing camera of the mobile device 50 that is configured to face the user of the vehicle 12. The analysis may, for example, determine that the user's hands on the steering wheel are clearly visible in the image and that the user's face is clearly visible in the image, as well as determining that no obstacles are present. Facial recognition may be employed on the image obtained by the rear-facing camera to identify and track the user and the facial recognition can use the AI processor 94 to determine whether the captured image is matched to a pre-stored set of images on which the AI processor 94 has been trained. This would be particularly helpful as the user may not be perfectly in line with the camera for facial recognition and so use of the AI processor 94 with a partial image to determine the identity for the user would be particularly useful. It will be appreciated that the user also needs to view the external environment during operation of the vehicle 12, so the mobile device 50 is configured (positioned) to ensure that the user has a significantly unobstructed view through the vehicle windows, for example the mobile device 50 may be positioned at a location which is in the peripheral vision of the user as they would be viewing the road ahead.

In a further configuration process, configuration comprises a data entry phase. In the data entry phase, parameters are set, either by the user or automatically, to configure the supervisory monitoring system to the exact vehicle and set-up of the mobile device 50 within the vehicle 12. Parameters such as the vehicle type, the vehicle autonomy level, the relative position of the mobile device 50 within the vehicle 12 and to the user, a required level of supervision, the identity of the user, the identity of any passengers, and a destination and/or an envisaged route of the vehicle 12 are set so that the mobile device 50 can adapt its operation to its setting. In response, the mobile device 50 adapts how it processes received information in accordance with one or more of these parameters. In an example, in response to the vehicle type being set, the supervisory monitoring system 40 communicates with the supervisory system content provider server 42 to access data relating to that vehicle type, the type of autonomy that vehicle 12 operates, and any pertinent information as to how the vehicle is likely to react in particular situations. In this regard, the type of autonomy system 14 that the vehicle 12 operates may either be available from predetermined information provided by the vehicle manufacturer or by looking at AI models created by other users previously which have been uploaded to the supervisory system content provider server 42. The mobile device 50 accesses its own stored data (either on the mobile device 50 itself or from the autonomy system content provider server) to determine whether it has previously supervised operation of that vehicle 12, and any details about the operation of the vehicle 12 in the previous instance that were recorded. The mobile device 50 recalls instances where the vehicle's operation was unforeseen or where a malfunction occurred. This information may also be available within the trained AI model of this vehicle 12 which was previously created on the mobile device 50 and uploaded to the supervisory system content provided server 42. Accordingly, if not already in the mobile device 50, this information can be downloaded from the supervisory system content provider server 42.

A yet further configuration process comprises disabling one or more features of the mobile device 50 during a driving period. In some embodiments of this process, disabling one or more features comprises automatically disabling functions of the mobile device 50 such as receiving notifications so that the user is not distracted otherwise or data communication to particular locations so that sensitive data of the user is adequately protected. Alternatively or additionally, disabling comprises the user identifying features to be disabled and/or features to be enabled according to their own preference. Other user preferences, such as the volume of alerts, the type of alerts, or the arrangement of a graphical user interface, are also configurable at this stage, either via adjusting individual settings, activating a pre-determined profile, or otherwise.

The configuration is preferably performed prior to the vehicle 12 beginning its operation (prior to the start of a driving period) but it is also possible to be performed while the vehicle 12 is operating autonomously. The mobile device 50 may be reconfigured while the vehicle 12 is operating autonomously. In some embodiments, the mobile device 50 automatically determines that the user is in a vehicle 12 and requests the user to confirm whether they wish for supervision functions on the autonomy system 14 to be performed.

Once the mobile device 50 has been configured in the vehicle 12, a new driving period commences, and this is determined by the supervisory monitoring system 40 at Step 404. Once the new driving period has commenced and has been determined by the supervisory monitoring system 40, the mobile device 50 begins its main function of providing monitoring of the operating conditions of the vehicle 12 and analysing the monitoring data it receives to alert the user accordingly.

The start of a new driving period is determined, at Step 404, by the user physically indicating to the mobile device 50 via the user interface that a new driving period has begun, or by an automatic function where the mobile device 50 identifies the start of the driving period. The automatic determination by the mobile device 50 is performed based on a successful completion of configuration of the device in the vehicle 12, on movement indicative of the start of a driving period of a vehicle 12 being identified, the movement of the vehicle 12 at a pre-determined speed, the presence of the user in the vehicle 12 relative to the device, and/or other indicators that a driving period is beginning. For example, for automatic determination, the mobile device 50 senses, via the accelerometer of the mobile device 50, that there is forward acceleration of the vehicle 12. Where the device is automatically detecting the start of a new driving period, this acceleration by the vehicle 12 above a predetermined level is taken as an indication that the new driving period has begun.

After the start of a new driving period has been determined, at Step 404, the mobile device 50 collects monitoring data, at Step 406. Monitoring data is any data that can be gathered by the mobile device 50 using one or more of its sensors 56, the navigation systems 60, the user interface 62, the communications engine 64, and any other data-receiving module, such as external, connected sensors. The collection of monitoring data begins at Step 406, and it is envisaged that the collection of monitoring data continues during each of the later steps in the process. In other words, monitoring data is continuously collected during a driving period.

Examples of monitoring data include one or more of the following: static images and/or videos obtained from the front-facing and/or rear-facing cameras 72, radar data from the one or more UWB sensors 92, sound data obtained from the one or more microphones 74, acceleration data from one or more accelerometers 76 within the mobile device 50, positional data including relative and absolute orientation, altitude and location, gathered from the compass 82, GPS system 80, or a gyroscope 78 within the mobile device 50, altimeter 84 or other sensors, traffic information and/or weather information obtained via the communications network 18, weather data from the barometer 86, and data relating to the location such as speed limit data for the roads and the demographics or type of area surrounding the road. Receiving monitoring data relating to the demographics or type of the area is important in understanding the type of hazards or threats that are experienced by the vehicle 12. The area type is also useful to access hazard types. This type of monitoring data is typically received from external sources to the mobile device 50. Other examples of monitoring data received from external sources include data from wearable devices or other connected devices within the vehicle 12, such as a smartwatch to determine biometric parameters of the user (driver) for example a heart rate of the user.

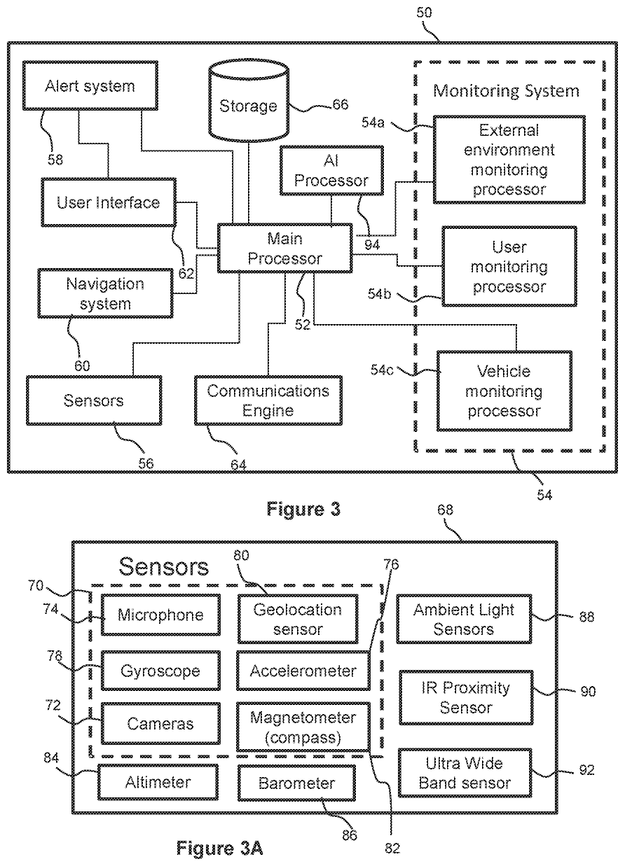

The collection of monitoring data, at Step 406, permits the mobile device 50 to perform one or more analysis processes, at Step 408, as indicated by processes B, C, D, E, F, or G, which are depicted in FIGS. 5 to 10 respectively. Each of the analytics processes B to G provides a different monitoring function and is performed by the main processor 52 and/or the AI processor 94 implementing the monitoring software program. In some implementations of the processes, some or all of the parts of the device 50, particularly the Al processor 94, main processor 52, and monitoring system 54, may work in sync to deliver the results of the methods and perform the appropriate analysis. The AI processor 94 is particularly used in analysis of the vehicle's actions and simulation of expected actions performed by the vehicle 12 to be compared against the autonomy system. In use, the AI processor 94 can be considered to be equivalent or substantially equivalent to the autonomy system 14 in terms of its processing capabilities without being able to control the vehicle 12.

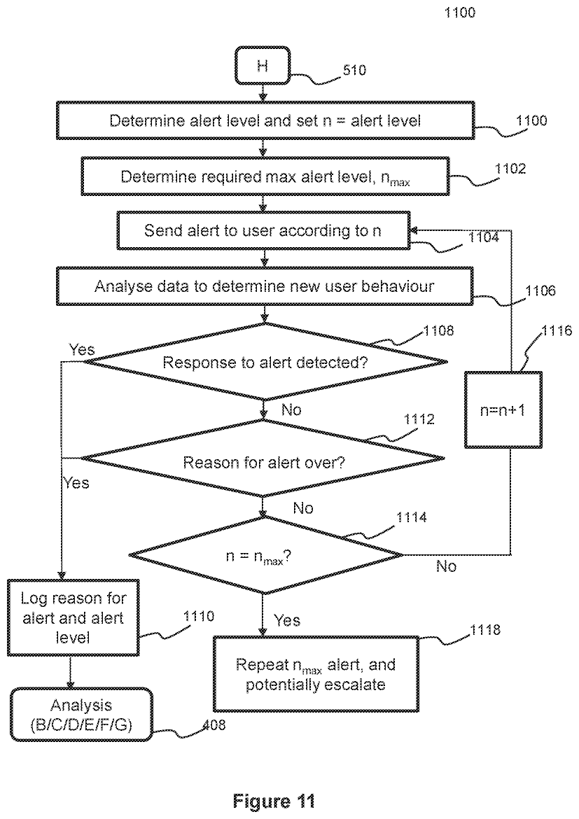

The analytics processes B to G are not mutually exclusive, so may be performed concurrently in any combination or individually. When the processes are performed concurrently, a hierarchy of analysis, i.e. which processes take priority, may be implemented to ensure that the mobile device 50 prioritises safety and optimises data transfer and available processing power. It is envisaged that one or more of the optional processes of B to G and the optional Alert Process H (FIG. 11) are performed repeatedly until the driving period has ended. Above it was described how the driving period start was indicated either by the user or automatically. Similarly, the end of the driving period is determined when the user indicates via the mobile device 50 that it has ended, or is determined automatically when the mobile device 50 detects via its collection of sensor data that the vehicle 12 is inactive, i.e. not being actively driven for example stationary and the ignition turned off.

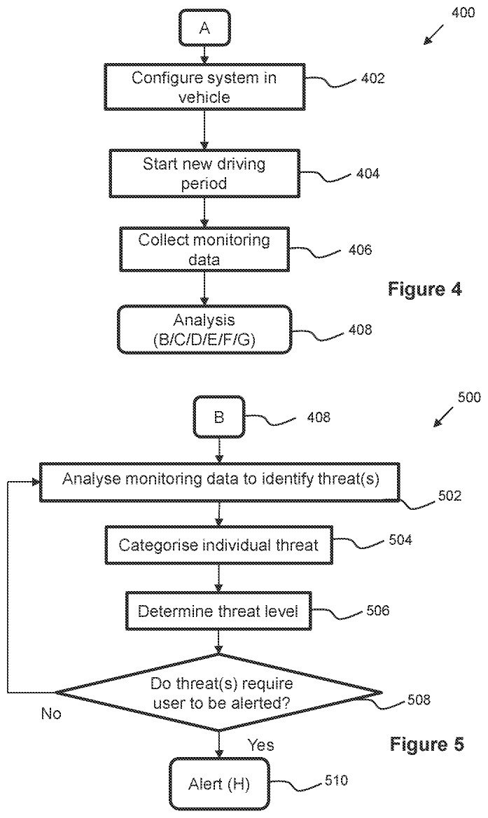

The analysis processes B and C of FIGS. 5 and 6, and which may follow the process of FIG. 4, are generally methods in which the external environment of the vehicle 12 is monitored as opposed to the interior or the general operation of the vehicle 12. The external environment is monitored to identify threats or hazards and to alert the user to these threats whilst the vehicle 12 is being driven as required. Whilst monitoring during the period of time that the autonomy system 14 is operative is of particular interest, the period of time the supervisory monitoring system 40 is operative can also cover the whole driving period even when the user is driving manually in a semi-autonomous vehicle 12. This has the advantage of alerting the user if they are, for example, distracted during driving and their attention to driving is suboptimal. In these cases, when the supervisory monitoring system 40 identifies a danger, the supervisory monitoring system 40 can alert the user to take appropriate action.

In FIG. 5, following the process of FIG. 4, the mobile device 50 analyses, at Step 502, the monitoring data collected in Step 408. The analysis is performed in this Step 502 to identify threats in the exterior environment to the vehicle 12.

Subsequently, it is determined, at Step 508, whether the severity of the identified threat/threats is enough to require the user to be alerted. If yes, an alert process is begun at Step 510. An example alert process 510 is provided in FIG. 11, signified by the letter H, and will be discussed later. If the threat is not severe enough to require an alert, the process running on the mobile device 50 returns to Step 502 and continues to analyse collected data.

In Step 502, the identification of a threat preferably comprises analysing the monitored data relating to the external environment, identifying objects or features of the external environment and the actions that that object is taking, and determining if one or more of the objects or features constitute a threat.

Categorisation of the threat at Step 504 is generally according to how soon action needs to be taken. An example categorisation comprises three levels of threats: immediate threats, such as another vehicle swerving in front of the vehicle 12 being monitored; medium-term threats, such as the identification of another vehicle acting erratically but not yet acting dangerously with respect to the vehicle 12 being actively monitored; and long-term threats; such as identification of high-density traffic further along the road in relation to the vehicle 12 being actively monitored. The identification of threats is dependent on various vehicle and environmental parameters, such as the location, road type, road surface quality, vehicle type, vehicle autonomy level, current speed, acceleration, direction of travel, occupancy or other operational parameter of the vehicle 12, and/or other aspects such as time of the day, season, traffic data, or road quality.

At Step 506, the threat level is determined based on the categorised individual threats. In embodiments, categorisation and determination of threats comprises assigning, to each feature or object, a threat level, based on analysis of the data received relating to the threat and assigning, to each individual aspect identified in the external environment, a value corresponding to its risk to the vehicle 12 being monitored. The overall threat level is therefore a function of all the values assigned to the individual aspects, such as the sum, mean, and/or maximum of the values, so that an overall threat level can be assigned to the external environment. In embodiments, the threat level is determined by increasing a threat level each time a new individual threat is identified (and decreasing the threat level when an individual threat is identified as having passed, with the threat level beginning from a base reference level at the beginning of the driving period. The value by which the threat level is increased or decreased depends on the categorisation of the threats. In other embodiments, the threat level is determined by a predictive mechanism applied the mobile device 50 whereby potential outcomes are identified and a level of threat is assigned based on the likelihood of the outcomes. These predictive outcomes may have been predetermined or determined through use and analysis by the AI processor 94. In some embodiments, the threat level is assigned by identification of a predetermined scenario.

In some examples, the supervisory monitoring system 40 identifies whether nearby vehicles are being operated manually or autonomously and identifies threats based on this data—manually operated vehicles are more likely to pose a threat than autonomously-operating vehicles and so would be identified as a higher level or category threat than autonomously-operating vehicles. Vehicle tracking data is utilised to make this determination and for use in identification of threats otherwise. The supervisory monitoring system 40 is configurable to perform one or more vehicle tracking operations, which may include the following: determining the number and density of other vehicles and determining a threat if the number or density of other vehicles is higher than an average value; identifying the speed of surrounding vehicles and determining a threat based on the speed of the vehicles in general or relative to the speed limit for that area—if all vehicles are travelling above the speed limit, a threat level is higher than would otherwise be assigned to the environment; in motorway settings, tracking the behaviour of particular vehicles over time to identify whether that vehicle is behaving erratically. Vehicles are most common on roads, but other objects are also sometimes present; the supervisory monitoring system 40 is configured in some embodiments to utilise the sensor data to identify foreign objects other than vehicles in the road, such as animals or debris, and categorise them as threats. The same is true for weather and its intensity, which is also capable of being assigned a threat level.

In the same way as identification of threats is dependent on various environmental and vehicle parameters, one or more of the same parameters may be used for the categorisation and/or assignation of a threat level.

At Step 508, it is determined whether the threat requires a user to be alerted. This is performed by setting an alert condition. Where a threat level is used, the alert condition includes a predetermined threshold or a set of thresholds of conditions and/or parameters against which the value of the threat level is compared. Where threats are categorised, the alert condition comprises the identification of one particular category of threat or the identification of a predetermined number of threats in a category and/or the identification of a temporal threat, namely a type of threat that has persisted for a predetermined time period. In some embodiments, the alert condition includes a weighted value based on operating parameters of the vehicle 12. A high vehicle density is likely to be less of a risk to a stationary vehicle than to a vehicle travelling at high speed and so a combination of different sensor parameters can be used to define an alert condition. The alert condition may comprise the identification of a predetermined threat or scenario that has been stored in the vehicle's data store. It is also possible to provide a plurality of alert conditions against which the threat level is compared. This will be discussed in more detail in relation to FIG. 11.

In addition to identifying threats in the external environment, the interior of the vehicle 12 also presents potential threats. An internal monitoring process 600, shown in FIG. 6, monitors the user using the sensors of the supervisory monitoring system 40 in order to ensure that the user's behaviour is adequate to react to any threats that are identified. In other words, the process 600 is a process that monitors both the external environment and the interior of the vehicle 12 to better tailor the alerts it provides.

Collected monitoring data relating to the external environment and the interior of the vehicle 12 (internal environment) at least is analysed, at Step 602, to identify threats and user behaviour. The determination of a threat level is here depicted in a separate step, Step 604. The determination of threat level described above in relation to Steps 502, 504 and 506 of FIG. 5 is also applicable to the determination of threat level in this process 600.

Having determined the threat level, at Step 604 of FIG. 6, a required user alertness appropriate for the threat level is determined at Step 606. In other words, the supervisory monitoring system 40 identifies how the user should be behaving for the user to adequately respond to the threat or threat level identified.

Concurrently, the supervisory monitoring system 40 determines, at Step 608, the current user alertness by analysing collected monitoring data relating to the interior of the vehicle 12. In an example, the rearward-facing (with respect to the vehicle's main direction of movement) camera is used to monitor the user. Analysis of images or sequences of images obtained by the camera are analysed by the supervisory monitoring system's user monitoring processor to identify patterns of data (signifiers) which signify user alertness (attention) such as: the position of the user within the vehicle 12; the user's body position; the direction the user is facing; whether the user's eyes are open or closed; where the user's eyes are focussed (if they are open); where the user's hands are and whether they are on the steering wheel; items the user is interacting with such as a book, mobile device 50, food, or drink; whether there are other passengers in the vehicle 12 and whether the user is interacting with those other passengers; the blink rate of the user; the speed it takes the user to physically react to an alert; yawning and how often the user is yawning; and breathing rate of the user based on analysis of images of the user's chest. Monitoring of the user is also performed by the supervisory monitoring system's microphone. Sound data from the supervisory monitoring system's microphone is analysed to determine signifiers of user alertness such as: breathing rate of the user; whether the user is talking to other passengers; whether the user is responding vocally to alerts. In some instances, sound data is analysed to recognise speech and determine a topic of conversation in order to determine whether the user is paying attention to the external environment. The supervisory monitoring system 40 is also capable of analysing data received from other devices within the vehicle 12 to identify signifiers of user alertness. Data from wearable devices (not shown) may be analysed to identify biometric parameters of the user such as heart rate, breathing rate, perspiration, caffeine level, alcohol level, and/or blood oxygen level of the user.

Although described here as a user alertness, it is envisaged that user alertness encompasses any aspect of the behaviour of the user that would impact how quickly the user is able to perform tasks within the vehicle 12, particularly how quickly the user is able to return to manual control of the vehicle 12 in response to the occurrence of an alert condition. For example, if the user is in the usual driving position, with their feet on the pedals and their hands on the steering wheel of the vehicle 12 and with their attention focussed on the road, then the user will be considered to be able to resume manual control very quickly. The supervisory monitoring system 40 may therefore also make use of stored examples of how the user responded to alerts previously for example using the AI processor, in order to make a determination of their overall alertness, as some users might not immediately react to alerts in the correct way, even if they are determined to be relatively alert. Furthermore, each user will have a different reaction time to an alert and so some understanding of previous response times can help to determine how early the alert needs to be generated by the supervisory monitoring system 40 for the user to react in time to avoid, for example, a driving hazard.

Accordingly, the user alertness is categorisable in terms of an alertness level or value, or in terms of an expected reaction time to return to manual control or to perform other tasks. The techniques described above are also applicable to the determination of required user alertness, determined at Step 606.

Once the required alertness of the user for the threat level and the actual alertness of the user have both been determined, at Steps 606 and 608, the supervisory monitoring system 40 determines if the current alertness meets the required alertness by carrying out a comparison at Step 610.

If the user's alertness does not meet the required level, the internal monitoring process 600 progresses, at Step 510, to an alert procedure such as the procedure H of FIG. 11. If the user's alertness is at the required level, then the process 600 returns to the analysis step, at Step 602, thereby continuing to monitor the threat and user's alertness to ensure that the requirements continue to be met.

In some embodiments, instead of using sensor data from the supervisory monitoring system's sensors to passively monitor the user's behaviour and alertness, the supervisory monitoring system 40 requires input from the user via the user interface to ensure that the user is at the correct alertness level. In such devices, the required alertness for the threat level is determined and based on the user responses to requests from the supervisory monitoring system 40 for input from the user. For example, the user periodically has to ‘check-in’ to the supervisory monitoring system 40 by interacting with it via the user interface or by speaking a particular phrase to demonstrate their alertness and attention. If the user does not interact with the supervisory monitoring system 40 in the required manner within a predetermined time limit, then the user's current alertness is determined to not meet the required user alertness for the threat level.

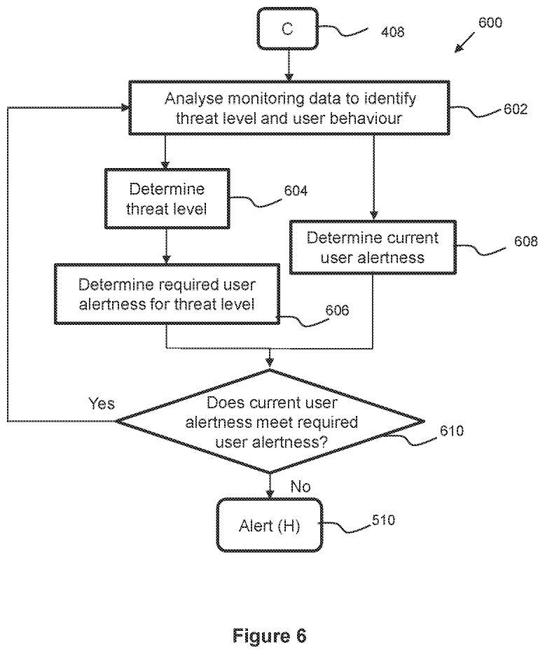

When considering user behaviour, in some circumstances the user engages in unsafe behaviour, causing an interior threat, either in the form of a threat to the user's own safety, or a threat to the vehicle 12 by not being able to resume manual control safely when a different threat arises. Even if no threat or hazards are identified in the external environment, it is important for the user to remain alert and, at the very least, not to engage in any behaviour that could be a risk to the continued operation of the vehicle 12 within the vehicle interior. Accordingly, the process, D 700, laid out in FIG. 7 monitors user behaviour and determines whether that user behaviour is safe.

Process D 700 commences with the monitoring data being collected and analysed, at Step 702, to determine user behaviour. User behaviour is typically identified in the same way that user alertness is determined in Process C 600 of FIG. 6, but it will be appreciated that any categorisation of user behaviour may be used. In particular, data collected from the sensors of the supervisory monitoring system 40 that monitor the interior of the vehicle 12 is used to identify how the user is behaving. The user's behaviour may be assigned a category or a behaviour level, with unsafe behaviour being a level of alertness that is categorisable in FIG. 6 or FIG. 7.

The process 700 continues with the supervisory monitoring system 40 determining, at Step 704, if the user's behaviour is safe or not. If the user's behaviour is determined to be safe, then the process 700 is returned to Step 702, and the monitoring and analysis of the user's behaviour continues. If the user's behaviour is determined, at Step 704, to not be safe, then the Alert Process H 510 of FIG. 11 is begun, or another alert process is begun.

The categorisation of unsafe behaviour is, in this non-limiting embodiment, dependent on the autonomy level of the vehicle 12. For example, in a Level 4 vehicle, the user reading a book at certain times during the driving period is not categorised as unsafe behaviour, whereas this behaviour is categorised as not tolerable in a Level 2 vehicle. Some actions are typically prohibited in all levels of vehicle, such as sleeping, not wearing a seatbelt, or drinking alcohol.

It is envisaged that the process 700 shown in FIG. 7 is performed before any other process is performed to identify whether the user is safe to operate the vehicle 12, although it could be performed at any time as appropriate.

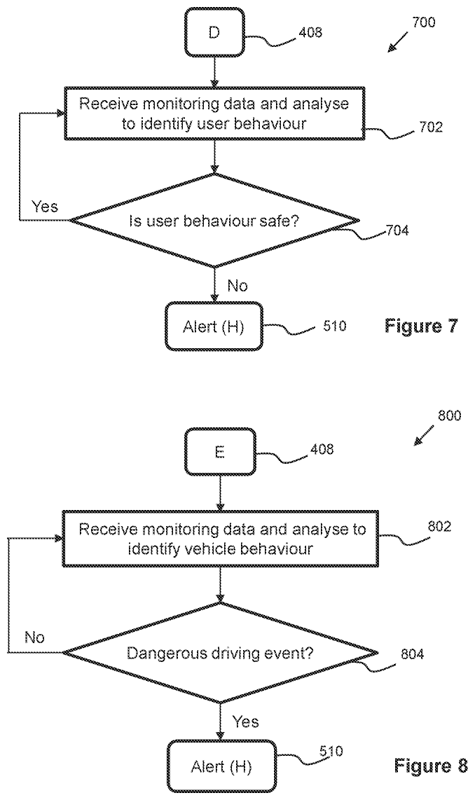

The user is not the only entity that can behave in an unsafe manner; the vehicle 12 is also capable of behaving in an unsafe manner. Erratic or dangerous vehicle control by the autonomy system would constitute unsafe behaviour. It is the supervisory system's prerogative to monitor the vehicle behaviour and driving events the vehicle experiences to enable determination of whether a dangerous driving event has occurred where actual driving outcomes deviate from expected driving outcomes. Based on this data, the system can attribute the behaviour to a vehicle malfunction. The Process E 800, shown in FIG. 8, is provided to monitor the behaviour of the vehicle 12 under control of the autonomy system in order to identify deviations from what is expected of the vehicle's autonomous operation, to identify any malfunctions, and to alert the user accordingly.

In FIG. 8, monitoring data is received by the processor and analysis is performed at Step 802, on the collected monitoring data. The analysis identifies the driving behaviour of the vehicle 12 for at least one driving event. The analysis is then used for comparison with a model of expected vehicle behaviour. Based on the vehicle driving behaviour, and any deviations of it from the expected behaviour, it is identified at Step 804, if there has been a dangerous driving event. If the vehicle 12 is behaving in an unexpected or unknown or erratic manner, there may have been a vehicle malfunction.

A dangerous driving event is identified by comparing the detected automated driving behaviour with a model of expected automated vehicle driving behaviour for a particular driving event. If there is a deviation of the detected behaviour from the model, there may have been a dangerous driving event by the vehicle. The deviation is compared with a threshold for the driving event to determine whether the driving event should be classified as dangerous or not.

In general, the model of expected driving behaviour is a rule or set of rules for reacting to a driving event. For some driving events, such as where the vehicle is driving within a region having a set speed limit, the model is the rule that the vehicle should travel at or below the set speed limit. In these types of event, where the model is an individual rule, the deviation can be determined as exceedance of the speed limit. The threshold can then be set as a dangerous speed level, depending on the limit, the type of road, and other factors. The threshold may be a percentage above the permitted limit. In other embodiments, driving events comprise complex situations, where modelling of the vehicle behaviour using simulation techniques and the AI engine are required. For example, in order to navigate a complex temporary traffic system where multiple vehicles are moving and there are temporary instructions for avoiding parts of the road, the AI engine's modelling function may be used to map an expected reaction of the vehicle. If the vehicle does something different, the deviation has occurred, and the processor may determine that a dangerous driving event has occurred, depending upon the threshold value.

The deviation may be quantified by comparing it against a classification framework. In other words, the processor determines a scale against which the deviation is comparable for the particular driving event. By generating a classification framework, the deviation is assignable a normalised value that may be comparable with a single uniform threshold, a value that can be compared with a predetermined or variable threshold specific to the event, and/or a category that is comparable with a category threshold. It follows, therefore, that the classification holds both a quantifier for the deviation, as well as the threshold. In some embodiments, a plurality of thresholds is provided, with each threshold corresponding to a different alert that the system generates and provides to the user (as will be explained later).

While the deviation is based on the action of the vehicle in the particular circumstance, the threshold against which it is compared may be based on other criteria. In particular, the threshold can be viewed as a measure of how dangerous the operation of the vehicle has to be before the supervisory system determines that the user should be warned, and manual control has to be retaken. Therefore, the system takes into account not only the type of driving event taking place and the external factors and operation of the vehicle and others, but also takes into consideration other factors that have an influence on how quickly manual control can be returned, and how much time will be required for the user to react to any threat once manual control is resumed. Therefore, the threshold is also based on one or more operational parameters, including a reaction time of the driver; a level of autonomy of the vehicle; condition of the vehicle; a road type; a weather condition; and one or more user settings. Where the threshold is based on reaction time, the system uses the interior monitoring sensors to determine how quickly the user is able to return to manual control based on their current behaviour. User settings may involve a setting indicating how critical the system is to be of the vehicle's behaviour.

If, having compared the model and the vehicle 12 is behaving in a normal and expected way, or at least within what is considered the normal bounds of operation, i.e. no dangerous driving event or even deviation is identified, then the process returns to receiving monitoring data and analysing the same, at Step 802. If the vehicle 12 displays erratic behaviour classified as a dangerous driving event, the method 800 moves to an alert process at Step 510, such as the Alert Process H, of FIG. 11.

As noted above, some dangerous driving events may be individual, one-off occurrences, but others may be indicative of or caused by vehicle malfunction. A non-limiting example of such malfunction is where the autonomy system operates the vehicle 12 at a speed above the current location's road speed limit. When the process 800 of FIG. 8 is performed using the supervisory monitoring system 40, the analysis, at Step 802, of the monitoring data determines a current location's speed limit, based on navigational metadata, and a current speed of the vehicle 12, based on received navigational data and/or image data. A comparison reveals that the vehicle's current speed exceeds the current location's speed limit. In a pedestrianised area where the speed limit is 30 miles per hour and that limit is being consistently exceeded, the supervisory monitoring system 40 identifies that such an exceedance is inappropriate and concludes that there may be a malfunction in the vehicle 12. The supervisory monitoring system 40 would therefore alert the user using one or more of the alert modules according to the alert process. However, in a motorway setting, where the speed limit is 70 miles an hour, the supervisory monitoring system 40 identifies that the vehicle 12 is exceeding this speed limit, but also that there is a heavy goods vehicle located in an inside lane relative to the vehicle 12, or that there is a vehicle attempting to change lanes. In these circumstances, a brief or temporary exceedance of the speed limit is generally accepted as permissible and would not be classified as a malfunction by the supervisory monitoring system 40. The supervisory monitoring system 40 may continue to monitor, at Step 802, the speed of the current vehicle 12 to identify whether the exceedance continues, and if it appears that there is exceedance of the speed limit without reason, the alert process, at Step 510, is begun.

Other examples of malfunction are jerky movements of the vehicle 12 identified by an accelerometer, failing to stop fully at stop signs, failing to recognise warning signs or alerts on roadsides, failing to stop at pedestrian crossings, missing turnings, or veering out of the correct lane on a motorway. These are malfunctions in the controlling operation of the autonomy system. Malfunctions in the general operation of the vehicle 12 are also identifiable by the supervisory monitoring system 40. For example, the noise of the vehicle 12 can be recorded and analysed to identify any potential engine problems and/or tyre issues and or exhaust issues in the main hardware of the vehicle 12. Similarly, problems with the vehicle suspension can be detected through use of the accelerometer readings, with for example a greater frequency of vertical acceleration readings indicating a lack of absorption of movement caused by an uneven road surface.

A vehicle malfunction may be a systematic malfunctioning or may be a random malfunctioning. For example, if a sensor is not operational or is returning flawed measurements to the autonomy system, the vehicle 12 systematically functions in an unexpected manner over a long period of time. If a sensor is temporarily obscured or experiences a minor fault that is quickly rectified, the malfunction may be random and only experienced for a short period of time. The supervisory monitoring system 40 can, in its analysis of data, compare two or more incidences of vehicle behaviour in reaction to a comparable threat or occurrence in the exterior environment and identify whether the malfunction is repeating itself or whether the error has been rectified. Accordingly, the analysis, at Step 802, which is a continuous process as new monitoring data is received, may need to determine results both instantaneously, based on the monitoring data, but also over a period of time, to better distinguish between random malfunctioning issues and systematic malfunctioning issues. The supervisory monitoring system 40 acts accordingly to the faults identified.

If a systematic fault has occurred, the alert provided, at Step 510, to the user may be more urgent or of a higher level than if the fault is due to a random malfunctioning issue. For apparently random errors, the supervisory monitoring system 40 may continue to monitor, at Step 802, the operation of the autonomy system with a particular focus on the potential malfunction in case the malfunction is identified again and in case it develops into a more serious, systematic malfunction.

It is important to note that a malfunction does not necessarily have to be a change from conventional operation. A malfunction can also occur as a mistake in or a missing part of the vehicle's processing functions or information that is programmed into the autonomy system. An example malfunction of this type is a lack of recognition by the vehicle of a particular type of road surface where the vehicle's speed needs to be reduced, for example uneven temporary road surfaces or cobbled road surfaces, that results in an inadequate reduction in speed of the vehicle when approaching these types of road surface. Another example of this type of malfunction is where road markings are not well defined, such as in rural areas where the road surface has been weathered away. These occurrences are considered to be malfunctions even though the operation of the vehicle was not at fault according to its own autonomy system.

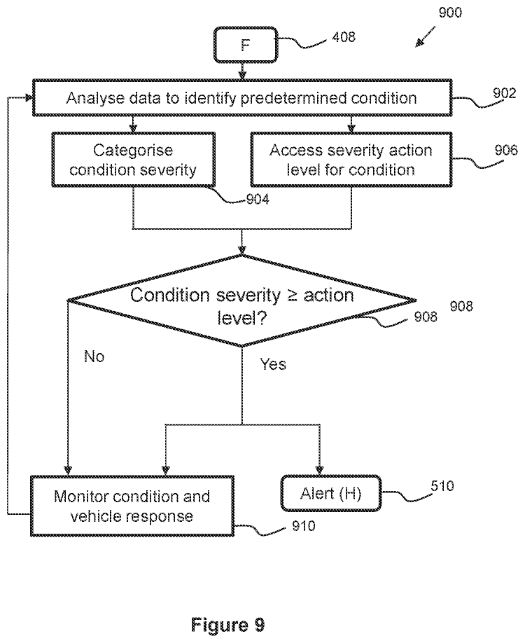

During the process of FIG. 8, the supervisory monitoring system 40 determines that the malfunction of the vehicle 12 was in response to certain conditions such as an occurrence in the external environment or was preceded by a sign from the vehicle 12 itself. For instance, a common occurrence in the external environment is precipitation, such as snow. Vehicles also commonly produce signs of malfunction in the form of repetitive noise detectable by the supervisory monitoring system 40. FIG. 9 provides a method F 900 of monitoring these kinds of previous conditions that might lead to vehicle malfunctions. The conditions are not limited to the present vehicle 12, but are also conditions that affect vehicles of the same type, and/or semi-autonomous vehicles in general. That is to say that the supervisory monitoring system 40 may be aware of the condition based on a previous malfunction by the current vehicle 12, malfunctions in other, similar vehicles, either of the same type or same autonomy level, and/or known flaws in semi-autonomous vehicles in general. By monitoring such conditions, the method F 900 also enables vehicle malfunctions under these conditions to be pre-empted by alerting the user in due time before the situation becomes too severe for action to be taken.

The method 900 commences by analysing at Step 902, the monitoring data with a focus on predetermined conditions that previously caused vehicle malfunctions. The analysis, at Step 902, is performed to identify one or more of the predetermined conditions. Identification may comprise one or more of accessing locally stored predetermined conditions; accessing an updated list of predetermined conditions periodically from the supervisory system content provider server 42, the period being each time a new driving period begins or at a predetermined time interval such as every day; and/or receiving from the supervisory system content provider server 42 a pushed data package including updated list of predetermined conditions to the supervisory monitoring system 40 when a connection to the content server is established via the communications network.

If a predetermined condition is identified, the supervisory monitoring system 40 establishes, at Step 904, the severity of the condition and categorises, at Step 904, it accordingly. The categorisation, at Step 904, includes assignation of a threat level assigned in the same or a substantially similar way as the threat level is assigned, assignation of discrete categories; categorisation based on the updated list of predetermined conditions; and/or categorisation based on data within a data package accompanying the updated list.

Concurrently, a severity action level for the condition is also identified, at Step 906. In embodiments, the severity action level is delivered to the supervisory monitoring system 40 from the supervisory system content provider server 42 at the same time as receiving the updated list of predetermined conditions so that it is readily accessible and stored with the predetermined conditions. The supervisory monitoring system 40 may alternatively or additionally access the action levels from the supervisory system content provider server 42 whenever the condition is identified or calculate the action level, as the action level may a variable that depends upon other parameters such as location of the vehicle 12, road surface, vehicle wear, or any other parameter influential on the operation of the vehicle 12 in its autonomous modes.

Having categorised the severity of the condition and accessed an action level, the severity and action level are compared at Step 908. If the condition severity is greater than or equal to the action level, the supervisory monitoring system 40 enters an alert process, at Step 510, and also specifically monitors, at Step 910, the condition and the vehicle's response to the condition in more detail than it would otherwise. If the condition severity is not greater than or equal to the action level, no alert process is begun, but the condition is monitored, at Step 910, in more detail. After either step, the supervisory monitoring system 40 continues to analyse data monitored specifically in relation to the condition and other data gathered by the supervisory monitoring system 40, by returning to Step 902.

In some embodiments, the supervisory monitoring system 40 alerts the user to the fact that it has identified a predetermined condition and is monitoring it at the beginning of the method, regardless of the severity of the condition.

In addition to monitoring malfunctions of the current vehicle 12, this method may also be used to identify other vehicles that pose a risk to the current vehicle 12 in particular conditions. Predetermined conditions are configurable in which manual vehicles pose more of a risk, such as icy conditions, or in which autonomously operated vehicles operating on a specific operating system pose a significant risk because of earlier malfunctions in the same conditions.

The expectation is that autonomy in road vehicles will be effective in preventing a large number of road-traffic incidents. However, it is still possible that a vehicle acting autonomously may be part of an incident alone or involving other semi-autonomous or autonomous vehicles, or pedestrians, manually operated vehicles. The supervisory monitoring system 40 provides important oversight if an incident occurs.

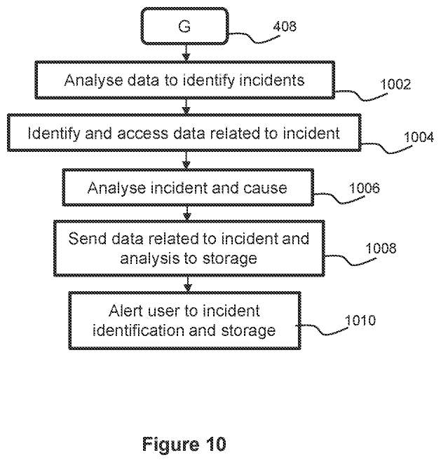

The process, G 408, in FIG. 10 is performed to ensure that incidents are properly logged, particularly for insurance purposes. In FIG. 10, the data is analysed, at Step 1002, to identify incidents. The term ‘incident’ is intended to include at least collisions, and optionally near-misses and sudden malfunctions. Collisions and near-misses are identifiable based on accelerometer data from the supervisory monitoring system 40 combined with image and noise data from the supervisory monitoring system 40.

If an incident is identified, the supervisory monitoring system 40 accesses, at Step 1004, any data that is considered to be relevant to the incident. Particularly, the device, making use of a buffer in which data is stored for a predetermined time period after being collected, accesses older data leading up to the incident. The supervisory monitoring system 40 subsequently analyses, at Step 1006, the incident and its cause. In some embodiments, Step 1006 is optional and analysis is performed at a later stage or not at all.

The data and any analysis performed are sent, at Step 1008, to more secure and permanent storage. This may comprise storing the data in a memory location within the supervisory monitoring system 40, and/or communicating it via the communications network to a server and database remote from the supervisory monitoring system 40 for later access. Having secured the data the supervisory monitoring system 40 alerts, at Step 1010, the user to the incident identification and that it has been securely stored.

In some embodiments, the method also comprises performing a check to identify an injury to the user. If, at Step 1002, an incident is identified and meets one or more predetermined emergency conditions indicating that the incident is sever, the user's health may be assessed and the emergency services automatically alerted by the supervisory monitoring system 40 that an incident has occurred, what the incident was, how many users are in the vehicle, where the incident took place, and any other pertinent information suitable for assisting the emergency services. Automatic alerting of the emergency services may also be provided if the incident is a collision with a pedestrian.

Although each of the above methods in FIGS. 5 to 10 is considered to be independent of others, it will be appreciated that different elements of each process can be combined or that the processes may be run concurrently. In some instances, the processes are performed in a hierarchical manner based on the available data, or the alerts in response to concurrent processes are prioritised. For example, a likely vehicle malfunction parameter is more urgent to a user than an upcoming junction, so the processes may be prioritised to provide the alert process to the user based on the vehicle malfunction. In some embodiments, where multiple threats or potential malfunctions are identified, a likelihood of the threat or malfunction developing parameter may be assigned to each, and the alerts provided prioritised according to this likelihood parameter. Instead of a likelihood parameter, a severity of the potential outcome parameter of ignoring the threat or malfunction may be assigned. In some embodiments, the likelihood parameter and severity parameter may be combined.

Alerts to the user may be delivered by any of a plurality of different methods. In the supervisory monitoring system 40, the alert system comprises an alert module that determines hardware with which to alert the user. Particularly where the device is a mobile device 50, it is envisaged that the alert module is connected to one or more loudspeakers of the supervisory monitoring system 40, a display or interface of the supervisory monitoring system 40, a vibration generator of the supervisory monitoring system 40, a flash for one or more of the device cameras, and/or the communications engine in order to communicate with external devices, such as wearables that are configured to alert the user using other vibration generators, loudspeakers, or displays, or external warning devices such as lights that flash warnings.

When alerting the user via the display or loudspeaker, the supervisory monitoring system 40 provides warning messages, indicating exactly what is required of the user or explicitly identifying the threat, and/or warning noises to bring the user's attention back to the road. Speech synthesis may be used to provide such warnings via the loudspeaker, and the user may reply vocally, so that the user is in effect in dialogue with the supervisory monitoring system 40.

FIG. 11 illustrates an exemplary alert process, H 1100. The process dictates how the supervisory monitoring system 40 should alert the user and escalate the alerts should no action be taken by the user.

The alert process 1100 commences with an appropriate alert level for the identified threat, incident, behaviour, or condition being determined and an initial alert level, n, being set, at Step 1102. The alert level may initially be set to 0 at the beginning of the driving period.

A maximum alert level, nmax, is then determined, at Step 1104, that is also appropriate to the threat. The maximum alert level is the alert level to which the system escalates if no action is taken by the user in response to previous alerts.

Having determined n and nmax, at Steps 1100 and 1102, an alert is sent at Step 1104, to the user via the supervisory monitoring system 40 or a connected device according to the alert level n. The alert may be specific to the type of threat it is in response to. For example, the alert level, n, is used to determine parameters of the alert, such as its duration, how loud or bright it is, how many times it is repeated, or how many different kinds of alert are used at once. If a low-level threat is identified such as a traffic jam some distance ahead, i.e. a low value of n, so that the alert is a low-level alert such as only notifying the user at a normal volume that a threat has been identified via the loudspeaker. For higher-level threats, such as a vehicle in the immediate vicinity acting erratically, i.e. a high value of n, the supervisory monitoring system 40 may immediately alert the user both via the screen and the loudspeaker and at a high volume and brightness, repeatedly identifying the threat.

Once the alert has been sent, at Step 1104 the supervisory monitoring system 40 analyses, at Step 1106, data received since the alert to identify new behaviour in the user. Here, the supervisory monitoring system 40 is gathering data to identify whether the user has responded to the alert.

The supervisory monitoring system 40 determines, at Step 1108, if a response to the alert has been identified in the user behaviour. A response to the alert may be dependent upon the type of threat, or to the alert level. In some embodiments, if the threat is particularly severe, the user may be required to immediately return to manual control of the vehicle 12. In other circumstances, the user turning their attention to the road may be a sufficient response to satisfy the supervisory monitoring system 40. The response required may in some embodiments be a more positive affirmative action of the user acknowledging the threat or the alert, either verbally or by providing input to the supervisory monitoring system 40 interface.

If a response, or, at the very least, an adequate response is detected at Step 1108, the supervisory monitoring system 40 logs the alert and the alert level reached at Step 1110, and continues to analyse, at Step 408, the environment using the analysis processes such as B to G. The supervisory monitoring system 40 sends no further alerts as long as the user is acting in the required way.

If a response is not detected or an inadequate response is detected at Step 1108, the device checks, at Step 1112 to see whether the threat is still present. If the threat is over and no longer present, the reason for the alert and the alert level are recorded at Step 1110. If the threat is still present and has not been overcome or avoided, the supervisory monitoring system 40 checks, at Step 1114, to see if n is at nmax. If n is not equal to the maximum alert level, n is increased by 1, at Step 1116 and returns to Step 1104 and sends a new alert, at Step 1104, to the user according to the increased n value. If n is equal to nmax, as determined at Step 1114, the alert is repeated and, if the alert is serious enough, an escalation procedure is entered at Step 1118. Escalation may involve alerting emergency systems or remotely accessing the vehicle control system and commanding it to pull over.

Although it is envisaged that the supervisory monitoring system will be provided ready-to-use by the user, the user may train the system in some embodiments. Using machine learning algorithms, the supervisory monitoring system 40 may monitor the operation of the vehicle 12 in both the manual and autonomous driving modes, and monitor the user's exemplary actions. Using the training data obtained from the user and vehicle 12 in these circumstances, the supervisory monitoring system 40 may subsequently tailor its monitoring and alerts to the user and the vehicle 12.

In particular, the system may monitor threats and hazards and correlate the identified threats and hazards with reactions of the user in response. The system would therefore be able to monitor the user to extract identifiers that the user is aware of a particular hazard. When acting as the supervisory monitoring system, the system would analyse data to monitor hazards, access from memory a user identifier that corresponds to a reaction to that hazard, analyse monitoring data of the user to determine whether the user identifier is present, and if not, alert the user to the hazard. This is particularly useful as different users are likely to have different habits, and different body language. Such a system may also enable better detection of poor user behaviour, such as the user being intoxicated or if the user is becoming too tired to continue driving.

Moreover, the system is also able to gain knowledge of threats based on the user's reaction to situations, and the relevant evasive action that needs to be taken. This can then be applied in autonomous circumstances. By parsing data from many different drivers, a large amount of training data may be gathered with which to further refine machine learning algorithms for use in a supervisory monitoring system.

In some circumstances, the use of machine learning in combination with training data from a user in manual control on a lower-level semi-autonomous vehicle may enable the collection of sufficient data to train the system for higher-level autonomous vehicles. The opposite may also be true—training the system on higher-level vehicles may enable their use with lower-level systems.

Although the above description describes the user of a supervisory monitoring system 40 in relation to vehicles operating autonomously, the supervisory monitoring system 40 may also be used in manual control conditions. The supervisory monitoring system 40 may be used by a user to improve their driving by providing analysis of their driving after the journey, so would be operated without alerts so as not to distract the user. Where the user of the supervisory monitoring system 40 is not the driver of the vehicle but a passenger, the supervisory monitoring system 40 may alert the user if the driver is driving in a dangerous manner. For example, in taxi/ride sharing services, the user may begin a new driving period and be discreetly warned of any possible threats that are not being taken into account by the driver. Accordingly, the feedback may be used to improve the quality of driving by taxi/ride sharing services. The data gained could be converted into a rating system for drivers and loaded to a central database. Such a system could be linked to a website to provide an independent review of drivers, giving them a rating that can be viewed by potential customers and employers alike. This would have the advantage of being a ‘cross-platform’ rating that monitors Uber®, Lyft® and other drivers in exactly the same way and is not subject to interference by the ride-share companies for commercial purposes.

Additionally, such a system may also provide an independent monitor of driving behaviour in vehicles for insurance purposes. Whilst insurance premiums will surely be lower for all drivers of autonomously-operated vehicles, it still follows that some drivers will be safer than others so their premiums could be lower still.

The use of a mobile device 50 such as a smartphone also permits greater possibilities for communication between vehicles. A threat identified by one device in a particular location may be communicated to devices in other vehicles that pass in the opposite direction so that they can be prepared for the threat ahead. Such communication would be achieved via the communications network or by a more local communications protocol such as Bluetooth®.

It is also to be appreciated that the term ‘interface’ as used within the specification is a broad term covering several different possible embodiments. For example, the interface can be a user interface such as a touchscreen of a mobile telecommunications device which acts as the monitoring device in one embodiment. In another embodiment it can be a screen and a keyboard or alternatively a display and interaction actuators, such a buttons, which enable the user to input commands. In a further embodiment, the user interaction interface can actually be provided on a device which is physically separate to the mobile monitoring device but which is functionally and operably linkable to the monitoring device via the interface.

1. A portable electronic monitoring device for providing an in-vehicle user warning system about how a semi-autonomous vehicle is being driven autonomously during a driving period, the device being removably and securely mountable to the vehicle and comprising:
a sensor set comprising at least one sensor for sensing an exterior environment outside of the vehicle and movement of the vehicle within the exterior environment,
an interface for receiving user input commands and delivering a warning output; and
a processor operatively connected to the sensor set and the interface;
wherein the sensor set is configured to monitor the automatic operation of the semi-autonomous vehicle within the exterior environment during the driving period and to generate sensor data representing driving events concerning the automated driving behaviour of the vehicle with respect to the exterior environment occurring during the driving period;
the processor being configured to:
process the sensor data during the driving period to compare the detected automated driving behaviour of the vehicle in the external environment with a model of expected automated vehicle driving behaviour for a particular driving event;
identify a dangerous driving event, if the detected automated driving behaviour deviates beyond a threshold from the expected automated vehicle driving behaviour; and
if a dangerous driving event has been detected, generate a warning alert via the interface to alert the driver to the occurrence of the dangerous driving event.

2. The portable electronic monitoring device according to claim 1, wherein the at least one sensor comprises a proximity sensor and the proximity sensor includes at least one of an infrared sensor, a camera, and/or an ultra-wide band sensor.

3. The portable electronic monitoring device according to claim 1, wherein the sensor set includes at least one external weather monitoring sensor.

4. The portable electronic monitoring device according to claim 1, wherein the portable monitoring device comprises a local wireless communications link to a personal telecommunications device which provides a user interface to the monitoring device.

5. The portable electronic monitoring device according to claim 1, wherein the sensor set includes at least one positional sensor and the at least one positional sensor comprises a gyroscope, a magnetometer, an altimeter, a geolocation sensor or an accelerometer.

6. The portable electronic monitoring device according to claim 1, wherein the sensor set includes an audio sensor and the sensor data includes audio signals.

7. The portable electronic monitoring device according to claim 1, wherein the interface comprises a touchscreen and a loudspeaker.

8. The portable electronic monitoring device according to claim 1, wherein the interface comprises a projector configured to project images onto a surface of the vehicle to create a head-up display.

9. The portable electronic monitoring device according to claim 1, wherein the monitoring device is a telecommunications device comprising a wireless communications engine for communicating with a remote server, wherein the wireless communications engine is configured to receive information regarding the external environment through which the vehicle is travelling.

10. The portable electronic monitoring device according to claim 1, comprising an Artificial Intelligence (AI) engine configured to operate as a neural network for learning and modelling autonomous behaviour of the vehicle, the processor being operatively connected to the AI engine.

11. The portable electronic monitoring device according to claim 10, wherein the AI engine comprises a neural network trained to model expected vehicle driving behaviour.

12. The portable electronic monitoring network according to claim 11, wherein the neural network is trained using sensor data collected from manual and/or automated operation of the vehicle prior to the current driving period.

13. The portable electronic monitoring network according to claim 12, wherein the sensor data collected prior to the current driving period is data that has been validated as being sensed in one or more driving periods during which no dangerous driving events were identified.

14. The portable electronic monitoring network according to claim 11, wherein, based on the neural network and sensor data, the AI engine is configured to generate the model of expected automated vehicle driving behaviour for the particular driving event.

15. The portable electronic monitoring device according to claim 1, wherein the processor is configured to:
determine a threshold for the particular driving event; and
if the comparison between the detected automated driving behaviour and the model of expected automated vehicle driving behaviour for the particular driving event indicates that a deviation has occurred:
compare the deviation and the threshold to determine if the deviation is beyond the threshold.

16. The portable electronic monitoring device according to claim 15, wherein the threshold is determined based on the driving event and at least one other parameter selected from the group consisting of: a reaction time of the driver; a level of autonomy of the vehicle; condition of the vehicle; a road type; a weather condition; and one or more user settings.

17. The portable electronic monitoring device according to claim 16, wherein the at least one other parameter comprises reaction time of the driver, and wherein the sensor set includes at least one sensor for sensing an interior environment of the vehicle, the processor being configured to determine the reaction time of the driver based on current and/or historical sensor data sensed from the sensor for sensing the interior environment of the vehicle.

18. The portable electronic monitoring device according to claim 16 , wherein the driving event comprises a vehicle manoeuvre and wherein the threshold is based on one or more of: vehicle speed during the manoeuvre; vehicle braking during the manoeuvre; and vehicle steering angle during the manoeuvre.

19. The portable electronic monitoring device according to claim 16, wherein the driving event comprises an interaction with another vehicle and wherein the threshold is based on one or more of: the speed of one or each vehicle during the interaction; vehicle braking during the interaction; the proximity of the other vehicle; the direction of travel of the other vehicle; the location of the other vehicle; whether the other vehicle is recognised as operating or capable of operating autonomously; and/or the behaviour of the other vehicle.

20. The portable electronic monitoring device according to claim 15, wherein the processor is configured to:
determine a classification framework for the particular driving event;
assign a value to the deviation of the detected automated driving behaviour from the expected automated driving behaviour based on the classification framework; and
compare the value with the predetermined threshold, and wherein the threshold is a value on the classification framework.

21. The portable electronic monitoring device according to claim 20, wherein the classification framework comprises a plurality of discrete category values.

22. The portable electronic monitoring device according to claim 20, wherein the classification framework comprises a continuous numerical scale of values.

23. The portable electronic monitoring device according to claim 1, wherein a plurality of thresholds is provided for identifying a dangerous driving event, and wherein each threshold corresponds to a different warning signal.

24. The portable electronic monitoring device according to claim 1, wherein the sensor set includes at least one sensor for sensing an interior environment of the vehicle.

25. The portable electronic monitoring device according to claim 23, wherein the sensor set is further configured to monitor the interior environment of the vehicle during the driving period and to generate sensor data representing a current attention state of the driver during the driving period.

26. The portable electronic monitoring device according to claim 24, wherein the processor is configured to:
determine a required attention state of the driver with respect to the current operation of the semi-autonomous vehicle within the exterior environment;
compare the current attention state of the driver and the required attention state of the driver; and
generate a warning alert signal if the current attention state deviates beyond a threshold value from the required attention state.

27. The portable electronic monitoring device according to claim 26, wherein the required attention state is determined based on one or more vehicle parameters.

28. The portable electronic monitoring device according to claim 27, wherein the one or more vehicle parameters includes a level of autonomy of the vehicle, a vehicle speed, a vehicle occupancy level, and/or a quality of autonomous vehicle operation.

29. The portable electronic monitoring device according to claim 26, wherein the required attention state is determined based on one or more external environment parameters.

30. The portable electronic monitoring device according to claim 29, wherein the one or more external environment parameters includes a road type, a road quality, a traffic density, a weather type, a classification of how urban or rural the environment is, driving behaviour of other vehicles in the vicinity, and/or the presence of one or more dangerous driving events and/or other threats.

31. The portable electronic monitoring device according to claim 1, wherein the processor is configured to, if a dangerous driving event is detected, determine a time point before which resumption of manual control of the vehicle is necessary, and to generate the warning signal before the time point at the latest.
